(19) United States
(12) Patent Application Publication
(10) Pub. No.: US 2024/0318838 A1
(43) Pub. Date: Sep. 26, 2024

(54) AIR SENDING DEVICE AND AIR-CONDITIONING APPARATUS

(71) Applicant: MITSUBISHI ELECTRIC CORPORATION, Tokyo (JP)

(72) Inventors: Katsuyuki YAMAMOTO, Tokyo (JP); Takuya TERAMOTO, Tokyo (JP); Atsushi KONO, Tokyo (JP); Tetsuji SAIKUSA, Tokyo (JP); Atsushi KIBE, Tokyo (JP); Hironori YABUUCHI, Tokyo (JP); Yuki NAKAO, Tokyo (JP)

(21) Appl. No.: 18/547,199

(22) PCT Filed: Apr. 27, 2021
(86) PCT No.: PCT/JP2021/016759

§ 371 Date: Aug. 21, 2023

(51) Int. Cl. F24F 1/38; F24F 1/0063; F24F 13/20

(52) U.S. Cl. CPC F24F 1/38; F24F 1/0063; F24F 13/20

(57) ABSTRACT

An air sending device includes: a housing; a fan motor; a fan configured to generate an air current; a motor support base provided upstream of the fan and the fan motor in a flow direction of the air current, and supporting the fan motor; and a rectifying member provided upstream of the motor support base, protruding in a direction from the motor support base toward the upstream side, and having a rectifying surface configured to change the flow direction of the air current such that the air current flows toward an inner circumferential region of the fan. The rectifying surface of the rectifying member includes an upstream-side distal end surface formed spherically, and a main surface located between the upstream-side distal end surface and the motor support base, forming an outer peripheral surface of the rectifying member, and tapered in a direction away from the motor support base.

### CROSS REFERENCE TO RELATED APPLICATION

This application is a U.S. national stage application of PCT/JP2021/016759 filed on Apr. 27, 2021, the contents of which are incorporated herein by reference.

### TECHNICAL FIELD

The present disclosure relates to an air sending device and an air-conditioning apparatus including the air sending device.

### BACKGROUND

An existing air-conditioning apparatus used as an outdoor unit includes a housing, a heat exchanger provided in the housing, and an air sending device that sends air to the heat exchanger (see, for example, Patent Literature 1).

In an air-conditioning apparatus described in Patent Literature 1, an air sending device has a rotation shaft, a boss portion fixed to the rotation shaft, a fan provided with a plurality of blades at an outer periphery of the boss portion, a fan motor that drives the fan, and a motor support base that supports the motor. In the air sending device, a conical rectifying member configured to rectify the flow of air that flows into the fan is provided in a region that is located below the motor and upstream of the rotation center of the fan. The conical rectifying member is tapered downwardly in a vertical direction.

In the air-conditioning apparatus described in Patent Literature 1, an air current that is present upstream of the rotation center of the fan is rectified by the conical rectifying member to prevent the air current from striking against the motor and thus reduce occurrence of turbulence of the air current.

### Patent Literature

Patent Literature 1: Japanese Unexamined Patent Application Publication No. 2020-122583

However, in Patent Literature 1, an upper end portion of the rectifying member has the same outside diameter as the motor, and the rectifying member has a triangular shape as viewed side-on. Furthermore, an extended line from the rectifying surface of the rectifying member extends toward the outside of the fan, and thus does not intersect the fan. Consequently, an air current that flows along a rectifying surface of the rectifying member does not flow to an inner circumferential region of the fan, but flows toward the outside of the fan. The air current that flows toward the outside of the fan partially strikes against the motor support base. For these reasons, in Patent Literature 1, it is not possible to obtain a sufficient rectifying effect.

In such a manner, the shape and size of the rectifying member greatly affect the flow of air to the fan and the flow of air that flows around the motor support base. However, in Patent Literature 1, the shape of the rectifying member and the relationship in size between the rectifying member and the motor support base are not fully discussed. Accordingly, in Patent Literature 1, it is not possible to obtain a sufficient rectifying effect.

### SUMMARY

The present disclosure is applied to solve the above problems, and relates to an air sending device and an air-conditioning apparatus that reduces the probability that an air current will strike against a motor support base, and thus facilitate the flow of the air current into an inner circumferential region of a fan, in order to improve a fan efficiency. It should be noted that the fan efficiency is the ratio of an air volume to the rotation speed of the fan.

An air sending device according to one embodiment of the present disclosure includes: a housing; a fan motor provided in the housing and having a rotation shaft; a fan attached to the rotation shaft and configured to be driven and rotated by the fan motor to generate an air current; a motor support base attached to the housing, provided upstream of the fan and the fan motor in a flow direction of the air current, and supporting the fan motor; and a rectifying member provided on an upstream side that is located upstream of the motor support base in the flow direction of the air current, protruding in a direction from the motor support base toward the upstream side, and having a rectifying surface configured to change the flow direction of the air current in such a manner as to cause the air current to flow toward an inner circumferential region of the fan. The rectifying surface of the rectifying member includes an upstream-side distal end surface formed spherically, and a main surface that is located between the upstream-side distal end surface and the motor support base, forms an outer peripheral surface of the rectifying member, and is tapered in a direction away from the motor support base.

An air-conditioning apparatus according to another embodiment of the present disclosure includes: the air sending device described above; and a heat exchanger provided in the housing. The heat exchanger is provided upstream of the air sending device in the flow direction of the air current.

The air sending device and the air-conditioning apparatus according to the embodiments of the present disclosure reduces the probability that an air current will strikes against the motor support base, and thus facilitates the flow of the air current into the inner circumferential region of the fan, thereby improving the fan efficiency.

### BRIEF DESCRIPTION OF DRAWINGS

FIG. 1 is a circuit diagram illustrating an example of a refrigerant circuit included in a refrigeration cycle apparatus 1 in which an air sending device 6 and an air-conditioning apparatus 100 according to Embodiment 1 are mounted.

FIG. 2 is a side view illustrating a configuration of an air-conditioning apparatus 100A.

FIG. 3 is a front view illustrating the configuration of the air-conditioning apparatus 100A.

FIG. 4 is a perspective view illustrating a configuration of a fan motor 61 and a motor support base 90 provided in the air-conditioning apparatus 100A.

FIG. 5 is a plan view illustrating the locations of heat exchangers 10 provided in the air-conditioning apparatus 100A.

FIG. 6 is a perspective view illustrating a configuration of an air-conditioning apparatus 100B that is a comparative example other than a comparative example illustrated in FIGS. 2 to 5.

FIG. 7 is a front view illustrating the configuration of the air-conditioning apparatus 100 according to Embodiment 1.

FIG. 8 is a partially-enlarged front view illustrating the configuration of the air-conditioning apparatus 100 according to Embodiment 1.

FIG. 9 is a partially-enlarged front view illustrating a configuration of an air-conditioning apparatus 100 according to Embodiment 2.

FIG. 10 is an explanatory view schematically illustrating the state of an air current in Embodiment 1.

FIG. 11 is a partially-enlarged front view illustrating a configuration of an air-conditioning apparatus 100 according to Embodiment 3.

FIG. 12 is an explanatory view illustrating a comparative example in the case where the relationship “W1>W2” is satisfied.

FIG. 13 is an explanatory view illustrating a comparative example in the case where the relationship “W1<W2” is satisfied and a virtual surface V1 intersects the motor support base 90.

FIG. 14 is a partially-enlarged front view illustrating a configuration of an air-conditioning apparatus 100 according to Embodiment 4.

FIG. 15 is a plan view illustrating the configuration of the air-conditioning apparatus 100 according to Embodiment 4.

FIG. 16 is a plan view illustrating the configuration of the air-conditioning apparatus 100 according to modification of Embodiment 4.

FIG. 17 is a front view illustrating the configuration of the air-conditioning apparatus 100 according to another modification of Embodiment 4.

FIG. 18 is a plan view illustrating a configuration of an air-conditioning apparatus 100 according to Embodiment 5.

### DETAILED DESCRIPTION

An air sending device and an air-conditioning apparatus according to each of embodiments of the present disclosure will be described with reference to the drawings. The present disclosure is not limited to the embodiments described below, and various modification can be made without departing from the gist of the present disclosure. In addition, the present disclosure encompasses all combinations of combinable ones of the configurations described regarding the embodiments and their modifications as described below. In each of figures in the drawings, components that are the same as or equivalent to those in a previous figure or previous figures are denoted by the same reference signs, and the same is true of the entire text of the specification. It should be noted that the relative relationships in size between components in each of the figures, the shapes of the components therein, etc., may be different from actual ones.

### Embodiment 1

### Configuration of Refrigeration Cycle Apparatus 1

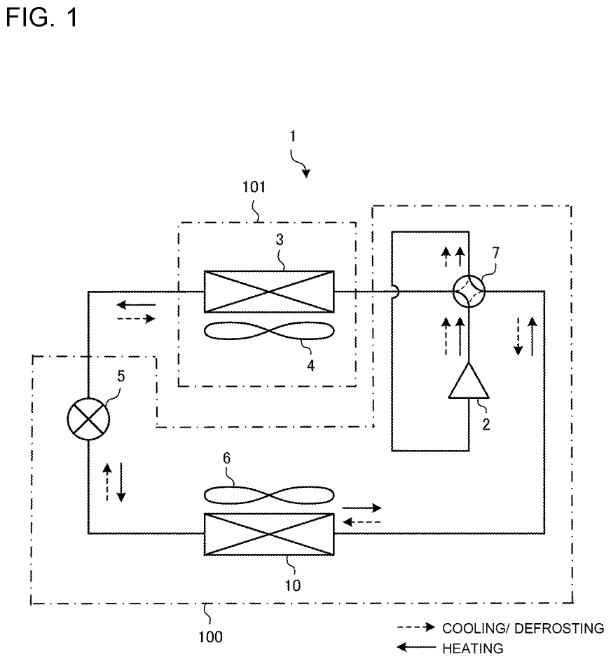

FIG. 1 is a circuit diagram illustrating an example of a refrigerant circuit included in a refrigeration cycle apparatus 1 that includes an air sending device 6 and an air-conditioning apparatus 100 according to Embodiment 1. With reference to FIG. 1, the refrigeration cycle apparatus 1 according to Embodiment 1 will be described below. As illustrated in FIG. 1, the refrigeration cycle apparatus 1 includes a compressor 2, an indoor heat exchanger 3, an indoor air sending device 4, an expansion device 5, a heat exchanger 10, an air sending device 6, and a four-way valve 7.

The compressor 2, the heat exchanger 10, the air sending device 6, the four-way valve 7, and the expansion device 5 are included in the air-conditioning apparatus 100 according to Embodiment 1. The indoor heat exchanger 3 and the indoor air sending device 4 are included in a second air-conditioning apparatus 101.

The compressor 2, the indoor heat exchanger 3, the expansion device 5, the heat exchanger 10, and the four-way valve 7 form a refrigerant circuit in which refrigerant can circulate. In the refrigeration cycle apparatus 1, a refrigeration cycle is carried out in which refrigerant circulates in the refrigerant circuit while changing in phase. Each of the components of the refrigeration cycle apparatus 1 as illustrated in FIG. 1 will be described below.

The compressor 2 has a suction port and a discharge port and is configured to compress refrigerant sucked from the suction port and discharge the compressed refrigerant from the discharge port. The compressor 2 is, for example, a rotary compressor, a scroll compressor, a screw compressor, or a reciprocating compressor. In addition, the compressor 2 may be an inverter compressor. In this case, the compressor 2 may cause the operating frequency of a motor that drives a compression mechanism of the compressor 2 to be arbitrarily changed by, for example, an inverter circuit, to thereby change a refrigerant discharge capacity per unit time. In the case where the compressor 2 is the inverter compressor, the inverter circuit is controlled by a controller (not illustrated).

The indoor heat exchanger 3 operates as a condenser when the refrigeration cycle apparatus 1 is in heating operation, and operates as an evaporator when the refrigeration cycle apparatus 1 is in cooling operation or defrosting operation. The indoor heat exchanger 3 causes heat exchange to be performed between indoor air supplied by the indoor air sending device 4 and refrigerant that flows in the indoor heat exchanger 3. The indoor heat exchanger 3 is, for example, a fin-and-tube heat exchanger.

The indoor air sending device 4 is provided for the indoor heat exchanger 3, and supplies indoor air to the indoor heat exchanger 3. For example, the indoor air sending device 4 is located to face the indoor heat exchanger 3. The indoor air sending device 4 includes, for example, an axial flow fan. The rotation speed of the indoor air sending device 4 is controlled by the controller (not illustrated).

The expansion device 5 is a pressure reducing device that expands refrigerant to reduce the pressure of the refrigerant. The expansion device 5 is, for example, an expansion valve. The expansion device 5 may be, for example, an electric expansion valve capable of adjusting the flow rate of the refrigerant. In this case, the expansion device 5 is controlled by the controller (not illustrated). The expansion device 5 may be a mechanical expansion valve in which a diaphragm is employed as a pressure receiving portion, or may be a capillary tube or similar members.

The heat exchanger 10 operates as an evaporator when the refrigeration cycle apparatus 1 is in heating operation, and operates as a condenser when the refrigeration cycle apparatus 1 is in cooling operation or defrosting operation. The heat exchanger 10 causes heat exchange to be performed outdoor air supplied by the air sending device 6 and refrigerant that flows in the heat exchanger 10. The heat exchanger 10 is, for example, a fin-and-tube heat exchanger including heat transfer tubes and fins.

The air sending device 6 is provided for the heat exchanger 10, and supplies outdoor air to the heat exchanger 10. The rotation speed of the air sending device 6 is controlled by the controller (not illustrated). The air sending device 6 is provided above the heat exchanger 10 or provided to face the heat exchanger 10. The air sending device 6 has, for example, an axial flow fan.

The four-way valve 7 is a flow switching device that switches the flow passage for the refrigerant between a plurality of flow passages in the refrigeration cycle apparatus 1. In FIG. 1, solid lines indicate the state of the four-way valve 7 in the heating operation of the refrigeration cycle apparatus 1, and dotted lines indicates the state of the four-way valve 7 in the cooling operation or defrosting operation of the refrigeration cycle apparatus 1. The state of the four-way valve 7 is switched between the above states by the controller (not illustrated). As indicated by the solid lines in FIG. 1, when the refrigeration cycle apparatus 1 is in heating operation, the state of the four-way valve 7 is switched to a state in which the four-way valve 7 connects the discharge port of the compressor 2 and the indoor heat exchanger 3 and connects the suction port of the compressor 2 and the heat exchanger 10. As indicated by the dotted lines in FIG. 1, when the refrigeration cycle apparatus 1 is in cooling operation or defrosting operation, the state of the four-way valve 7 is switched to a state in which the four-way valve 7 connects the discharge port of the compressor 2 and the heat exchanger 10 and connects the suction port of the compressor 2 and the indoor heat exchanger 3.

### Configuration of Comparative Example for Air-conditioning Apparatus 100

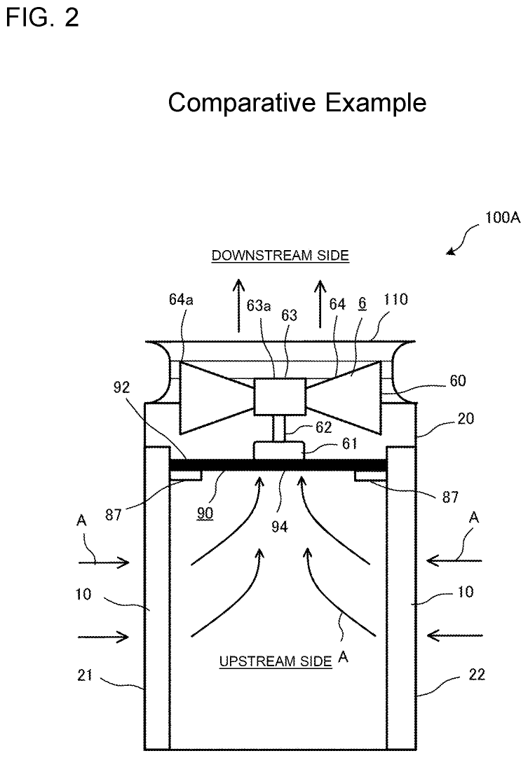

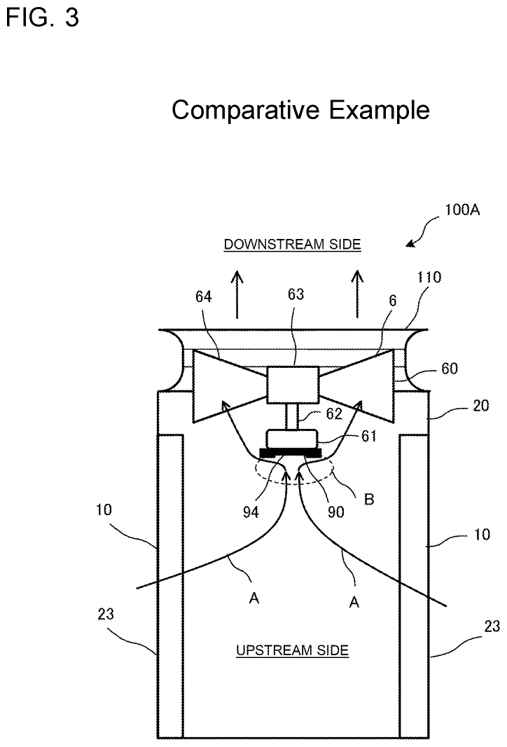

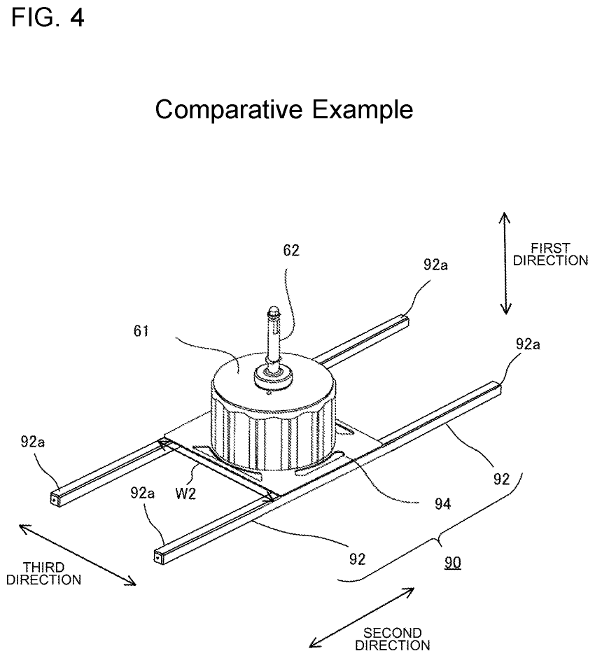

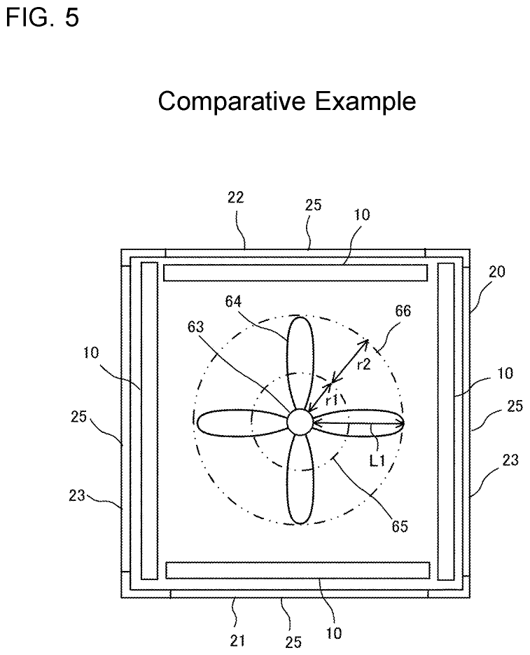

Prior to describing the configuration of the air-conditioning apparatus 100, the configuration of an air-conditioning apparatus 100A that is a comparative example for the air-conditioning apparatus 100 will be described below with reference to FIGS. 2 to 5. FIG. 2 is a side view illustrating the configuration of the air-conditioning apparatus 100A. FIG. 3 is a front view illustrating the configuration of the air-conditioning apparatus 100A. FIG. 4 is a perspective view illustrating the configuration of a fan motor 61 and a motor support base 90 provided in the air-conditioning apparatus 100A. FIG. 5 is a plan view indicating the locations of heat exchangers 10 provided in the air-conditioning apparatus 100A.

As illustrated in FIGS. 2 and 3, the heat exchangers 10 and the air sending device 6 are provided in the housing 20. The housing 20 is a housing of the air-conditioning apparatus 100A, and is also used as a housing of the air sending device 6. Although it is not illustrated, the compressor 2, the four-way valve 7, the expansion device 5, a control box, and other devices are further provided in the housing 20. As illustrated in FIG. 5, the heat exchangers 10 are provided to face respective four sides of the housing 20, that is, a front side 21, a back side 22, and two lateral sides 23. These four sides form outer peripheral portions of the housing 20. The four heat exchangers 10 are located individually along the four sides of the housing 20 and close to the four sides. The front side 21, the back side 22, and the two lateral sides 23 have respective opening portions 25 through which air is sucked from the exterior of the housing 20. When the air sending device 6 is rotated, air is sucked into the housing 20 from each of the opening portions 25 of the front side 21, the back side 22, and the two lateral sides 23 of the housing 20 as indicated by arrows A in FIGS. 2 and 3. The sucked air passes through the heat exchangers 10, flows through the air sending device 6, and is blown from an upper portion of the housing 20 to the outside of the housing 20. Therefore, in the housing 20, a lower portion of the housing 20 is located on an upstream side in the flow direction of the air current, and the upper portion of the housing 20 is located on a downstream side in the flow direction of the air current. Arrows A each indicate the flow of air, that is, air current. It should be noted that it is described above that the opening portions 25 are provided on the respective four sides of the housing 20; however, it is not limiting. Basically, the opening portion or portions 25 are provided only on a side or sides which the heat exchanger or heat exchangers 10 are provided to face. Therefore, in the case where on not all the four sides of the housing 20, the heat exchanger or heat exchangers 10 are provided, the opening portion or portions 25 are provided only on a side or sides of the housing 20 for which the heat exchanger or exchangers 10 are provided.

In this example, four heat exchangers 10 are provided, and are located along respective sides of the housing 20, that is, the front side 21, the back side 22, and the two lateral sides 23 of the housing 20 as illustrated in FIG. 5. In such a manner, in this example, the four heat exchangers 10 are provided; however, three or less heat exchangers 10 may be provided. That is, it suffices that the heat exchanger 10 is located along at least one of the front side 21, the back side 22, and the two lateral sides 23 of the housing 20. The heat exchanger 10 causes heat exchange to be performed between air current supplied by the air sending device 6 and refrigerant that flows in the heat exchanger 10.

As illustrated in FIGS. 2 and 3, the air sending device 6 is provided downstream of the heat exchangers 10 in the flow direction of the air current. The air sending device 6 includes a fan 60 and a fan motor 61. The fan 60 and the fan motor 61 are attached to the housing 20 with the motor support base 90. Where the axial direction of the fan 60 and the fan motor 61 is a first direction, the longitudinal direction of the motor support base 90 is the same direction as a second direction intersecting the first direction as illustrated in FIG. 4. A short-side direction of the motor support base 90 is the same as a third direction that intersects the first direction and the second direction. The first direction is the axial direction of a rotation shaft 62 provided in the fan motor 61. The rotation shaft 62 will be described later. The first direction is, for example, a vertical direction. The second direction and the third direction are each, for example, a horizontal direction. The motor support base 90 has rod-like fixing portions 92 that extend in the second direction and a motor holding portion 94 that holds the fan motor 61. Both end portions of the fixing portions 92 in the longitudinal direction are attached to frames 87 (see FIG. 2) provided at the housing 20. The fixing portions 92 and the motor holding portion 94 are joined together by brazing or are formed integrally with each other.

As illustrated in FIG. 4, the motor holding portion 94 of the motor support base 90 is formed in the shape of, for example, a rectangular plate. The fan motor 61 is provided on an upper surface of the motor holding portion 94. Therefore, the fan motor 61 is provided downstream of the motor holding portion 94. The fixing portions 92 are, for example, rod-like members having a rectangular columnar shape. Two fixing portions 92 are located in parallel to each other as illustrated in FIG. 4. The motor holding portion 94 extends from a central portion of one of the fixing portions 92 to a central portion of the other fixing portion 92.

The fan motor 61 includes the rotation shaft 62 which protrudes upward in the first direction. The fan 60 is fixed to the rotation shaft 62. As illustrated in FIGS. 2 and 3, the fan 60 has a boss portion 63 at the center and blade portions 64 provided around the boss portion 63. An upper portion 63a of the boss portion 63 is located at a lower level than a top portion 64a of each of the blade portions 64 such that the boss portion 63 is not in contact with a fan guard portion 110. Since the periphery of the fan guard portion 110 is fixed, when a force is applied to the fan guard portion 110, a central portion of the fan guard portion 110 is most easily warped. Therefore, the upper portion 63a of the boss portion 63 is located at a lower level than the top portion 64a of the blade portion 64, thereby reducing the probability that the fan guard portion 110 will be brought into contact with the entire fan 60.

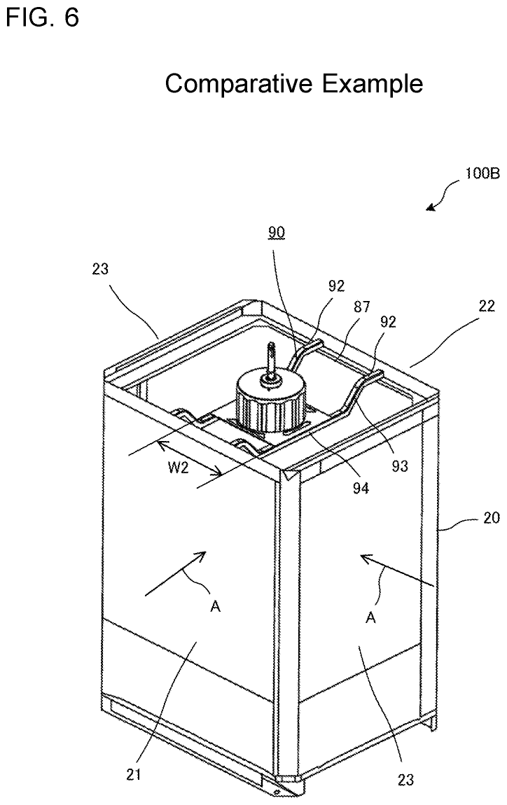

FIG. 6 is a perspective view illustrating the configuration of an air-conditioning apparatus 100B that is a comparative example other than the comparative example as illustrated in FIGS. 2 to 5. The air-conditioning apparatus 100B basically has the same configuration as the air-conditioning apparatus 100A, and is different from the air-conditioning apparatus 100A in the configuration of the motor support base 90. In the air-conditioning apparatus 100B, as illustrated in FIG. 6, the motor support base 90 includes the fixing portions 92, the motor holding portion 94, and connecting portions 93 each of which connects an associated one of the fixing portions 92 and the motor holding portion 94. As illustrated in FIG. 6, in the motor support base 90, the motor holding portion 94 is located at a lower level than the fixing portions 92. That is, the motor support base 90 is shaped such that the motor holding portion 94 protrudes downward from the fixing portions 92. The motor support base 90 is formed by, for example, bending. The fixing portions 92 and the motor holding portion 94 extend in the horizontal direction, and the connecting portions 93 are inclined relative to the horizontal direction. For example, the motor holding portion 94, the fixing portions 92, and the connecting portions 93 are formed integrally with each other.

In the air-conditioning apparatuses 100A and 100B which are provided as illustrated in FIGS. 2 to 5 and FIG. 6 and each of which includes no rectifying member, an air current that has passed through the heat exchangers 10 by driving of the air sending device 6 strikes against the motor support base 90 in a region B surrounded by the dotted line as indicated in FIG. 3. As a result, the air current greatly separates from the motor support base 90 and thus moves toward a region located outward of the fan 60 in a radial direction of the fan 60. Inevitably, the amount of an air current that flows into an inner circumferential region of the fan 60 is reduced and the fan efficiency of the fan 60 is thus reduced.

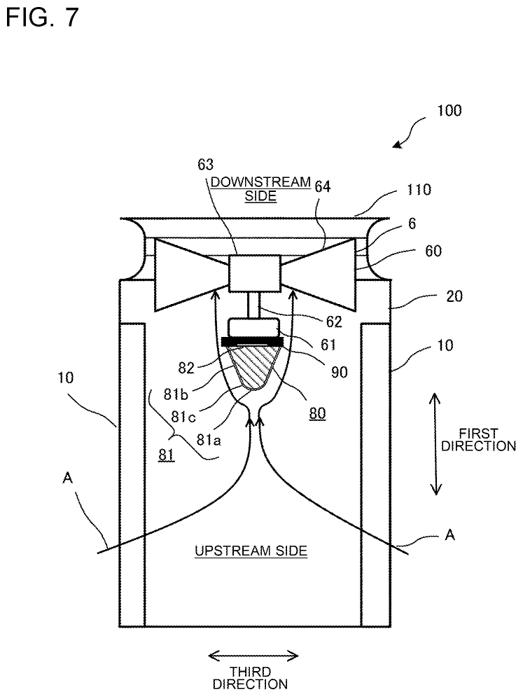

In view of the above, in the air-conditioning apparatus 100 according to Embodiment 1, a rectifying member 80 is provided upstream of the motor support base 90 as illustrated in FIG. 7. As a result, it is possible to reduce the probability that the air current will strike against the motor support base 90, and to facilitate the flow of the air current into the inner circumferential region of the fan 60, thereby improving the fan efficiency. Furthermore, since a distal end of a rectifying surface of the rectifying member on the upstream side is formed spherically, the air current can easily flow along the rectifying surface, and thus a larger amount of air current can flow into the inner circumferential region of the fan, thereby improving the fan efficiency.

It should be noted that as can be seen from FIG. 2, the air current also strikes against the fixing portions 92 of the motor support base 90. However, as illustrated in FIG. 4, since the fixing portions 92 are rod-like members, even when the air current strikes against the fixing portions 92, this does not greatly affect the flow direction of the air current. Therefore, regarding each of the embodiments as described below, in order to simplify explanations, descriptions concerning the case where the air current strikes against the motor support base 90 will be made in consideration of only the effect of an air current that strikes against the motor holding portion 94, without considering the effect of the air current that strikes against the fixing portions 92

### Configuration of Air-conditioning Apparatus 100

FIG. 7 is a front view illustrating the configuration of the air-conditioning apparatus 100 according to Embodiment 1. The air-conditioning apparatus 100 basically has the same configuration as that of the air-conditioning apparatus 100A as illustrated in FIGS. 2 to 5. However, in the air-conditioning apparatus 100, the rectifying member 80 is provided. In this regard, the air-conditioning apparatus 100 is different from the air-conditioning apparatus 100A. Therefore, the air-conditioning apparatus 100 will be described mainly regarding the differences between the air-conditioning apparatus 100 and the air-conditioning apparatus 100A. Components of the air-conditioning apparatus 100 that are the same as those of the air-conditioning apparatus 100A will be denoted by the same reference signs, and their descriptions will thus be omitted. The configuration of the motor support base 90 may be the same as that of the motor support base 90 of the air-conditioning apparatus 100A as illustrated in FIGS. 2 to 5, or may be the same as that of the motor support base 90 of the air-conditioning apparatus 100B as illustrated in FIG. 6.

As illustrated in FIG. 7, the rectifying member 80 is located below the fan motor 61. That is, the rectifying member 80 is provided upstream of the fan motor 61 in the flow direction of the air current. The rectifying member 80 is attached to the motor support base 90, and protrudes from the motor support base 90 toward the upstream side of the air current in the first direction. A distal end of the rectifying member 80 on the upstream side in the flow direction of the air current is formed in the shape of a spherical cone. The rectifying member 80 has a rectifying surface 81 that changes the flow direction of the air current, and a downstream-side end portion 82 fixed to the motor support base 90. The rectifying surface 81 includes an upstream-side distal end surface 81a and a main surface 81b. The upstream-side distal end surface 81a has a spherical shape. For example, the upstream-side distal end surface 81a is formed hemispherically. However, the shape of the upstream-side distal end surface 81a is not limited to the above shape. The upstream-side distal end surface 81a may have an outer shape formed into an arc with a preset central angle α as viewed side-on. The central angle α may be appropriately determined to fall within the range between 45° and 180°; however, preferably, the central angle α should fall within the range of 120°≤α≤180°. In addition, the upstream-side distal end surface 81a may have an outer shape that is a combination of two or more arcs with different radii as viewed side-on. The main surface 81b is located between the motor support base 90 and the upstream-side distal end surface 81a. The main surface 81b forms an outer peripheral surface of the rectifying member 80, and is a tapered surface that is tapered toward a direction away from the motor support base 90. That is, the outside diameter of the main surface 81b gradually decreases in the axial direction from the downstream side of the air current toward the upstream side of the air current. Where a portion connecting the main surface 81b and the upstream-side distal end surface 81a is a connecting portion 81c, the outside diameter of the connecting portion 81c is smaller than that of the downstream-side end portion 82 which is located an upper end portion of the main surface 81b.

A described above, the main surface 81b is a tapered surface, and the rectifying member 80 excluding the upstream-side distal end surface 81a has a trapezoidal sectional shape as viewed side-on. The upstream-side distal end surface 81a has an arc sectional shape as viewed side-on. The downstream-side end portion 82 of the rectifying member 80 is joined to the lower surface of the motor support base 90 by, for example, brazing. It should be noted that the downstream-side end portion 82 of the rectifying member 80 is an upper end portion of the rectifying member 80 in the vertical direction. The main surface 81b that forms the outer peripheral surface of the rectifying member 80 is formed into a smooth inclined surface to prevent friction from occurring between the main surface 81b and the air current. The connecting portion 81c connecting the main surface 81b and the upstream-side distal end surface 81a is formed into a smooth curved surface that is seamless between the main surface 81b and the upstream-side distal end surface 81a. Thus, an air current that flows along the rectifying surface 81 having the upstream-side distal end surface 81a and the main surface 81b does not separate from the rectifying member 80. It should be noted that as a matter of convenience of explanation, the rectifying surface 81 is separated into the upstream-side distal end surface 81a, the main surface 81b, and the connecting portion 81c, however, these surfaces are formed integrally to form a single rectifying member 80. The rectifying member 80 is made of aluminum, aluminum alloy, copper, copper alloy, or other material. The rectifying member may be made of resin. The rectifying member 80 may have a hollow structure in which its interior is hollow, or may not have the hollow structure.

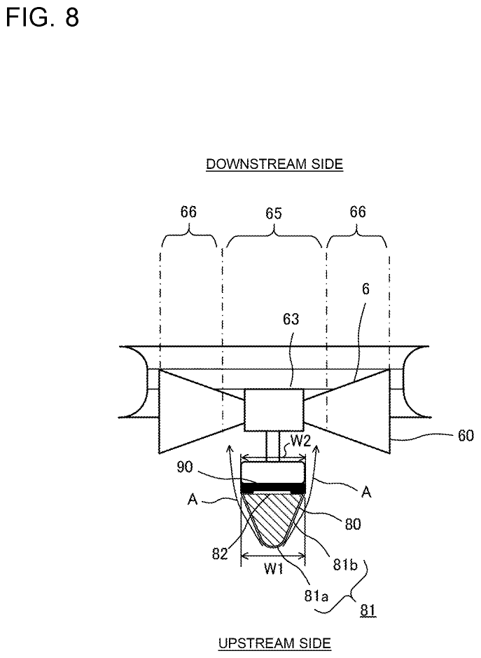

FIG. 8 is a partially-enlarged front view illustrating the configuration of the air-conditioning apparatus 100 according to Embodiment 1. As illustrated in FIG. 8, an outside diameter W1 of the downstream-side end portion 82 of the rectifying member 80 is equal to a width W2 of the motor support base 90. In this example, the width W2 of the motor support base 90 is the length of one side of the motor holding portion 94, as illustrated in FIG. 4. That is, in Embodiment 1, the relationship “W1=W2” is satisfied. Thus, as indicated by arrows A in FIG. 8, the air current flows along the main surface 81b of the rectifying member 80 without striking against the motor support base 90, and the flow of the air current into an inner circumferential region 65 of the fan 60 is thus facilitated. In general, the larger the amount of the air current flowing to the inner circumferential region of the fan, the further greatly the fan efficiency is improved. In Embodiment 1, the rectifying member 80 is provided, thus facilitating the flow of the air current into the inner circumferential region 65 of the fan 60, and improving the fan efficiency. It should be noted that the inner circumferential region 65 of the fan 60 is a circular region that is located around the boss portion 63 and has a radius r1 from the boss portion 63 as illustrated in FIG. 5. It should be noted that the radius r1 may be defined as a distance from the shaft center of the boss portion 63, however, in this example, the radius r1 is defined as a distance from an outer circumferential edge of the boss portion 63 as illustrated in FIG. 5. An outer circumferential region 66 of the fan 60 is a region that is located outward of the inner circumferential region 65. The outer circumferential region 66 is a donut-shaped region that is obtained by removing the inner circumferential region 65 from a circular region around the boss portion 63 and having a radius (r1+r2) from the boss portion 63. In this example, where L1 is the length of the blade portion 64 in the radial direction, the radius r1 is, for example, one third the length L1; that is, r1=⅓×L1. Alternatively, the radius r1 may be half the length L1. In such a manner, the radius r1 is appropriately set to fall within the range of, for example, ⅓×L1≤r1≤½×L1 in consideration of the shape of the blade portion 64 and other factors. It should be noted that the length L1 is the maximum value of the length of the blade portion 64 in the radial direction, regardless of the shape of the blade portion 64.

As described above, in the air-conditioning apparatus 100A that includes no rectifying member as in the comparative example illustrated in FIG. 3, an air current that has passed through the heat exchangers 10 by driving of the fan 60 strikes against the motor support base 90. Thus, the air current greatly separates from the motor support base 90 and flows toward a region that is located outward of the outer circumferential region 66 in the radial direction. Consequently, the amount of the air current that flows into the inner circumferential region 65 of the fan 60 is reduced, thus reducing the fan efficiency.

In contrast, in the air-conditioning apparatus 100 according to Embodiment 1, the rectifying member 80 is provided upstream of the motor support base 90 as illustrated in FIG. 7, thereby reducing the probability that the air current will strike against the motor support base 90. The outside diameter W1 of the downstream-side end portion 82 of the rectifying member 80 is equal to the width W2 of the motor support base 90. The main surface 81b of the rectifying member 80 changes the flow direction of the air current in such a manner as to cause the air current to flow toward the inner circumferential region 65 of the fan 60. Thus, the flow of the air current into the inner circumferential region 65 of the fan 60 is facilitated, thereby improving the fan efficiency. Furthermore, the upstream-side distal end surface 81a provided upstream of the main surface 81b has a spherical shape. Accordingly, the air current easily flows along the main surface 81b, thus increasing the amount of the air current that can flow into the inner circumferential region 65 of the fan 60, and further improving the fan efficiency.

As described above, in the air-conditioning apparatus 100 and the air sending device 6 according to Embodiment 1, the rectifying member 80 is provided upstream of the motor support base 90. The rectifying member 80 has the rectifying surface 81 configured to change the flow direction of an air current generated by driving of the fan 60. The rectifying surface 81 includes the main surface 81b which is tapered toward a direction away from the motor support base 90, and the upstream-side distal end surface 81a which is formed spherically. Since the air current flows along the rectifying surface 81 of the rectifying member 80, the flow of the air current into the inner circumferential region 65 of the fan 60 can be facilitated. Furthermore, since the rectifying member 80 is provided, it is possible to reduce the probability that the air current will strike against the motor support base 90. Thus, the air current can be prevented from flowing toward the outside of the fan 60 due to striking of the air current against the motor support base 90. It is therefore possible to further facilitate the flow of the air current into the inner circumferential region 65 of the fan 60. Accordingly, the fan efficiency can be improved. In addition, since the upstream-side distal end surface 81a of the rectifying surface 81 is formed spherically, the air current easily flows along the rectifying surface 81, thereby increasing the amount of the air current that can flow into the inner circumferential region 65 of the fan 60, and further improving the fan efficiency.

### Embodiment 2

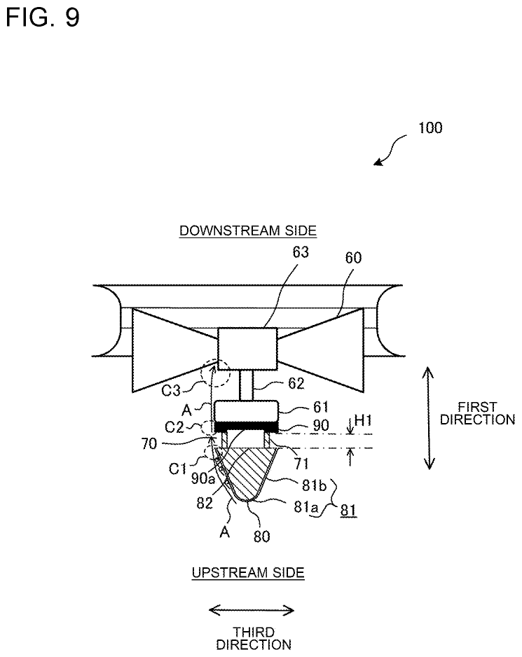

FIG. 9 is a partially-enlarged front view illustrating a configuration of the air-conditioning apparatus 100 according to Embodiment 2. In Embodiment 2, as illustrated in FIG. 9, a gap 70 having a length H1 is provided between an upstream-side end portion 90a of the motor support base 90 and the downstream-side end portion 82 of the rectifying member 80. In this regard, Embodiment 2 is different from Embodiment 1. Since the other structural elements are the same as those in Embodiment 1, and their descriptions will thus be omitted.

In Embodiment 2, as illustrated in FIG. 9, in order to provide the gap 70, supporting columns 71 each having a length equal to the length H1 are provided between the upstream-side end portion 90a of the motor support base 90 and the downstream-side end portion 82 of the rectifying member 80. The supporting columns 71 extend in the vertical direction and are rod-like members. The supporting columns 71 are provided inward of the outer peripheral edge of the downstream-side end portion 82 of the rectifying member 80 in order to prevent the air current from striking against the supporting columns 71. It is preferable that the number of the supporting columns 71 be larger than or equal to two.

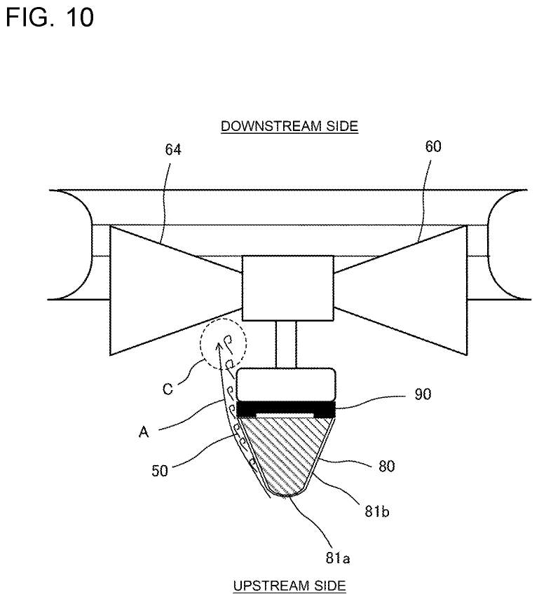

In general, when an air current flows along a wall surface, a boundary layer including turbulent part is generated between the air current and the wall surface due to an effect of friction between them. Therefore, a boundary layer 50 (see FIG. 10) is also generated at the main surface 81b of the rectifying member 80. The effect of the boundary layer 50 on the rectifying member 80 only is small. However, in the case where the motor support base 90 and the rectifying member 80 are adjacent to each other, or in the case where the motor support base 90 or the fan motor 61 has such a shape as to produce a rectifying effect, the effect of the boundary layer 50 on the above elements are great. That is, in the above cases, the boundary layer 50 generated at the main surface 81b of the rectifying member 80 grows to reach the motor support base 90 or the fan motor 61. Thus, when reaching the fan 60, the boundary layer 50 grows to the maximum. As a result, a turbulent air current including the boundary layer 50 flows toward the inner circumferential region 65 of the fan 60. Thus, there is a possibility that the fan efficiency may be reduced. In view of this, in Embodiment 2, as illustrated in FIG. 9, the gap 70 is provided between the motor support base 90 and the rectifying member 80 to cause the air current to separate from the rectifying member 80 once at the downstream-side end portion 82, and then to re-come into contact with the motor support base 90, thereby reducing the growth of the boundary layer 50, and reducing the probability that the turbulent air current will flow into the inner circumferential region 65 of the fan 60. It is therefore possible to improve the fan efficiency. This will be described below in detail with reference to FIG. 10.

FIG. 10 is an explanatory view schematically illustrating the state of the air current in Embodiment 1. In Embodiment 1, as illustrated in FIGS. 7 and 8, the upstream-side end portion 90a of the motor support base 90 and the downstream-side end portion 82 of the rectifying member 80 are located adjacent to each other in the flow direction of the air current. In Embodiment 1, the air current generally flows along the main surface 81b as indicated by an arrow A in FIG. 10. At this time, between the air current and the main surface 81b, the boundary layer 50 is created due to an effect of friction between the air current and the main surface 81b. As illustrated in FIG. 10, the boundary layer 50 gradually grows from the rectifying member 80 to the motor support base 90, and grows to the maximum in a region indicated by a dotted line C in FIG. 10. As a result, a turbulent air current flows into the inner circumferential region 65 of the fan 60.

In view of the above, in Embodiment 2, as illustrated in FIG. 9, the gap 70 is provided between the upstream-side end portion 90a of the motor support base 90 and the downstream-side end portion 82 of the rectifying member 80. That is, the upstream-side end portion 90a of the motor support base 90 and the downstream-side end portion 82 of the rectifying member 80 are located opposite to each other, with the gap 70 interposed between the upstream-side end portion 90a and the downstream-side end portion 82. An air current flows along the main surface 81b, a side surface of the motor support base 90, and a side surface of the fan motor 61 as indicated by an arrow A in FIG. 9. At this time, because of the presence of the gap 70, in Embodiment 2, the air current separates from the rectifying member 80 once at the downstream-side end portion 82 thereof in the region indicated by a dotted line C1 in FIG. 9. Thereafter, in a region indicated by a dotted line C2 in FIG. 9, the air current re-comes into contact with the motor support base 90.

Also, in Embodiment 2, the boundary layer 50 is formed between the air current and the main surface 81b as in Embodiment 1. As illustrated in FIG. 9, the boundary layer 50 gradually grows along the main surface 81b of the rectifying member 80. However, the air current separates from the rectifying member 80 at the downstream-side end portion 82, and as a result, the growth of the boundary layer 50 stops once. Thereafter, the air current re-comes into contact with the motor support base 90, thereby additionally forming a new boundary layer 50 between the air current and the motor support base 90. The new boundary layer 50 gradually grows from the motor support base 90 to the fan motor 61; however, this passage from the motor support base 90 to the fan motor 61 is shorter than that in Embodiment 1. Accordingly, the boundary layer 50 does not grow so greatly as in Embodiment 1. Therefore, in the region indicated by a dotted line C3 in FIG. 9, it is possible to reduce the probability that a turbulent air current will flow into the inner circumferential region 65 of the fan 60.

As described above, in Embodiment 2, since the rectifying member 80 is provided as in Embodiment 1, the flow of the air current into the inner circumferential region 65 of the fan 60 is facilitated, thereby improving the fan efficiency.

Furthermore, in Embodiment 2, the gap 70 is provided between the upstream-side end portion 90a of the motor support base 90 and the downstream-side end portion 82 of the rectifying member 80. It is therefore possible to cause the air current to separate from the rectifying member 80 once at the downstream-side end portion 82, and thereafter causes the air current to re-contact the motor support base 90. As a result, the growth of the boundary layer 50 stops once at the downstream-side end portion 82 of the rectifying member 80. Thus, even when a new boundary layer 50 is additionally formed on the motor support base 90, it is possible to reduce the growth of the total boundary layer 50 as a whole. Therefore, it is possible to reduce the probability that a turbulent air current will flow into the inner circumferential region 65 of the fan 60. Accordingly, the fan efficiency can further be improved as compared with Embodiment 1.

### Embodiment 3

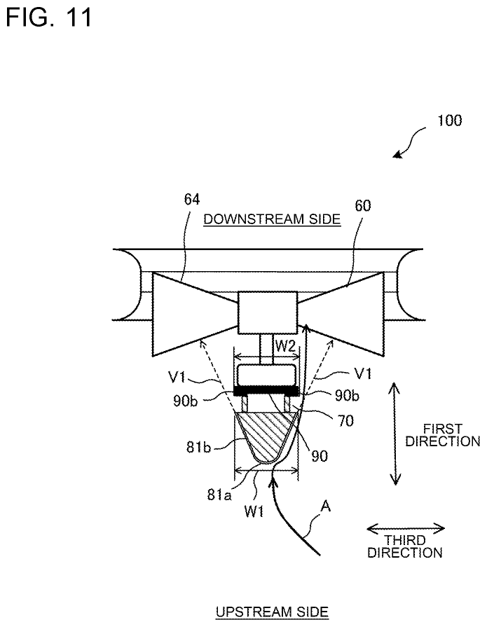

FIG. 11 is a partially-enlarged front view illustrating a configuration of the air-conditioning apparatus 100 according to Embodiment 3. The air-conditioning apparatus 100 according to Embodiment 3 basically has the same configuration as that of the air-conditioning apparatus 100 according to Embodiment 2. In Embodiment 3, as illustrated in FIG. 11, the outside diameter W1 of the downstream-side end portion 82 of the rectifying member 80 is smaller than or equal to a length W2 of the motor support base 90 in the short-side direction. That is, in Embodiment 3, the relationship “W1≤W2” is satisfied. Hereinafter, the length W2 of the motor support base 90 in the short-side direction will be referred to as a width W2 of the motor support base 90. As indicated by an arrow A in FIG. 11, the air current flows along the main surface 81b of the rectifying member 80 without striking against the motor support base 90, and the flow of the air current into the inner circumferential region 65 of the fan 60 is facilitated. Since the other structural elements are the same as those in Embodiments 1 and 2, their descriptions will thus be omitted.

It is assumed that as illustrated in FIG. 11, a virtual surface extending from the main surface 81b of the rectifying member 80 toward the downstream side as viewed side-on is a virtual surface V1. In Embodiment 3, since the relationship “W1≤W2” is satisfied, the virtual surface V1 does not intersect the motor support base 90 as illustrated in FIG. 11. That is, in the radial direction, the virtual surface V1 is located outward of both end portions 90b of the motor support base 90 that are end portions thereof in the short-side direction. It is therefore possible to reduce the probability that an air current that has separated from the downstream-side end portion 82 of the rectifying member 80 will strike against the motor holding portion 94 of the motor support base 90.

In Embodiment 3, the outside diameter W1 of the downstream-side end portion 82 of the rectifying member 80 is smaller than or equal to the width W2 of the motor support base 90, thereby reducing the probability that the flow passage of the air current will be narrowed. In Embodiment 3, the virtual surface V1 of the main surface 81b of the rectifying member 80 intersects the blade portion 64 of the fan 60. In the case where the virtual surface V1 is set to intersect a boundary line between the inner circumferential region 65 and the outer circumferential region 66, that is, an outer circumferential circle of the inner circumferential region 65, the fan efficiency is improved. However, this is not limiting. The virtual surface V1 may be set to intersect the outer circumferential region 66 of the blade portion 64 of the fan 60. In such a manner, it suffices that the position where the virtual surface V1 and the blade portion 64 intersect each other is appropriately set such that the maximum fan efficiency is obtained, in consideration of the shape of the blade portion 64 and other factors. As a result, the flow of the air current into the inner circumferential region 65 of the fan 60 is facilitated, thereby improving the fan efficiency.

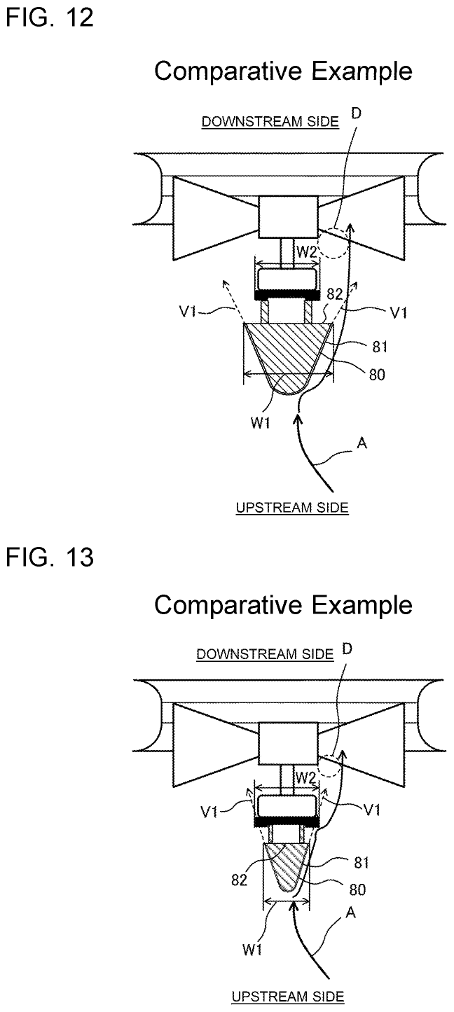

The advantages of Embodiment 3 will be described below by referring to comparative examples illustrated in FIGS. 12 and 13. FIG. 12 is an explanatory view illustrating a comparative example in the case where the relationship “W1>W2” is satisfied. FIG. 13 is an explanatory view illustrating a comparative example in the case where the relationship “W1<W2” is satisfied and the virtual surface V1 intersects the motor support base 90.

It will be discussed what result is obtained if the outside diameter W1 of the downstream-side end portion 82 of the rectifying member 80 is larger than the width W2 of the motor support base 90 as in the comparative example illustrated in FIG. 12. In this case, since the outside diameter W1 of the downstream-side end portion 82 is larger than the width W2 of the motor support base 90, the flow passage for the air current is narrowed as indicated by an arrow A. Consequently, the air current flows in a direction mainly toward the outer circumferential region 66, and the amount of the air current that flows into the inner circumferential region 65 is thus reduced. Thus, the air current does not flow into an inner region of the inner circumferential region 65 of the fan 60 that is indicated by a dotted line D in FIG. 12. In such a manner, in the comparative example illustrated in FIG. 12, the amount of the air current that flows into the inner circumferential region 65 of the fan 60 is reduced, thereby reducing the fan efficiency.

Next, it will be discussed what result is obtained if the outside diameter W1 of the downstream-side end portion 82 of the rectifying member 80 is smaller than the width W2 of the motor support base 90, and the virtual surface V1 of the main surface 81b of the rectifying member 80 intersects the motor support base 90 as in the comparative example illustrated in FIG. 13. In this case, as indicated by an arrow A, an air current having separated from the downstream-side end portion 82 of the rectifying member 80 strikes against the motor support base 90 and then separates from the motor support base 90. Consequently, the air current moves toward the outer circumferential side in the radial direction, and the amount of an air current that flows into the inner circumferential region 65 is thus reduced. Thus, the air current does not flow into, for example, the inner region of the inner circumferential region 65 of the fan 60, which is indicated by the dotted line D in FIG. 13. In such a manner, in the comparative example illustrated in FIG. 13, the amount of the air current that flows into the inner circumferential region 65 is reduced, and the fan efficiency is reduced.

As described above, in the case where the outside diameter W1 of the downstream-side end portion 82 of the rectifying member 80 is larger or much smaller than the width W2 of the motor support base 90, the amount of the air current that flows into the inner circumferential region 65 of the fan 60 is reduced, and the fan efficiency is reduced.

In view of the above, in Embodiment 3, the rectifying member 80 is formed such that that the relationship “W1≤W2” is satisfied and the virtual surface V1 of the main surface 81b extends toward the region located outward of the motor support base 90 in the radial direction. It is therefore possible to facilitate the flow of the air current into the inner circumferential region 65 of the fan 60, thereby improving the fan efficiency.

Since the probability that the air current flowing along the main surface 81b will strike against the motor support base 90 is reduced, the air current can smoothly flow into the inner circumferential region 65 of the fan 60 and this can greatly contribute to improvement of the fan efficiency. Therefore, in Embodiment 3, the rectifying member 80 is formed such that the downstream-side end portion 82 has an outside diameter W1 smaller than or equal to the width W2 of the motor support base 90, thereby to reduce the probability that the flow passage of the air current will be narrowed, and to cause the air current to flow into the inner circumferential region 65 of the fan 60. In addition, since the virtual surface V1 of the main surface 81b of the rectifying member 80 extends to a region located outward of the motor support base 90 in the radial direction, it is possible to reduce the probability that the air current having separated from the downstream-side end portion 82 will strike against the motor support base 90. Accordingly, it is possible to facilitate the flow of the air current into the inner circumferential region 65 of the fan 60, thereby improving the fan efficiency.

As described above, in Embodiment 3, the rectifying member 80 is provided as in Embodiments 1 and 2, thereby facilitating the air current that flows into the inner circumferential region 65 of the fan 60, and improving the fan efficiency.

In Embodiment 3, the gap 70 is provided between the upstream-side end portion 90a of the motor support base 90 and the downstream-side end portion 82 of the rectifying member 80 as in Embodiment 2. Thus, it is possible to reduce the growth of the boundary layer 50, and reduce the probability that a turbulent air current will flow into the inner circumferential region 65 of the fan 60.

Furthermore, in Embodiment 3, the relationship “W1≤W2” is satisfied and the virtual surface V1 of the main surface 81b extends to the region located outward of the motor support base 90 in the radial direction. By virtue of this configuration, it is possible to further facilitate the flow of an air current into the inner circumferential region 65 of the fan 60, and further improve the fan efficiency.

### Embodiment 4

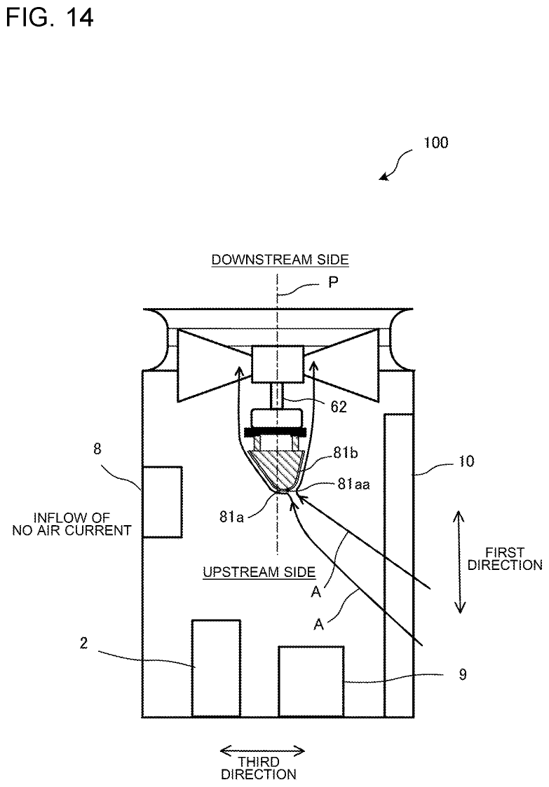

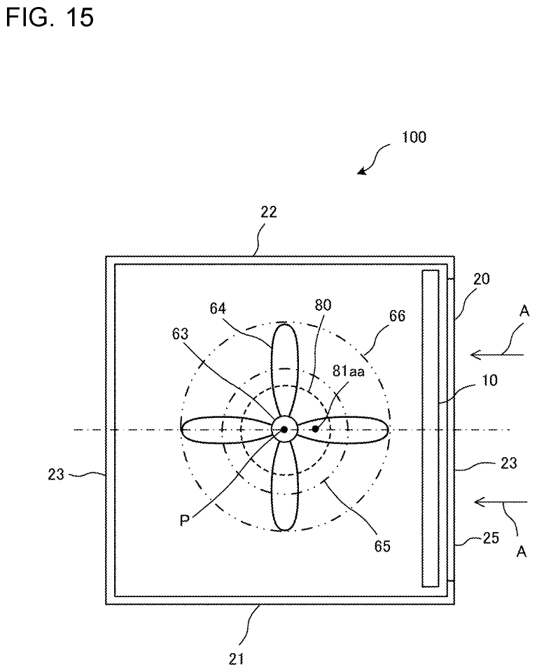

FIG. 14 is a partially-enlarged front view illustrating a configuration of the air-conditioning apparatus 100 according to Embodiment 4. FIG. 15 is a plan view illustrating the configuration of the air-conditioning apparatus 100 according to Embodiment 4. The air-conditioning apparatus 100 according to Embodiment 4 basically has the same configuration as that of the air-conditioning apparatus 100 according to Embodiment 2. In Embodiment 4, as illustrated in FIG. 14, an apex 81aa of the upstream-side distal end surface 81a of the rectifying member 80 is displaced from a central axis P of the fan 60. In this regard, Embodiment 4 is different from Embodiment 2.

As illustrated in FIG. 14, a center line of the fan 60 that extends in the axial direction is a central axis P. The central axis P corresponds to the shaft axis of the rotation shaft 62. In this case, the apex 81aa of the upstream-side distal end surface 81a is not located on the central axis P, but is located at a position shifted from the central axis P. The other structural element are the same as those in Embodiments 1 and 2, and their descriptions will thus be omitted.

In Embodiment 4, the heat exchanger 10 is provided to face only one of the lateral sides 23 of the housing 20 as illustrated in FIG. 15. Thus, as indicated by arrows A in FIGS. 14 and 15, an air current flows into the housing 20 from one of the lateral sides 23 of the housing 20, but does not flow into the housing 20 from any of the other lateral side 23, the front side 21, and the back side 22 of the housing 20. In view of this point, in Embodiment 4, in accordance with the flow direction of the air current, the apex 81aa of the upstream-side distal end surface 81a is located at a position shifted from the central axis P in the third direction toward the location of the heat exchanger 10. Specifically, the apex 81aa is located at a position shifted toward the opening portion 25 on the lateral side 23 of the housing 20 where the heat exchanger 10 is provided. The second direction intersects the first direction, and is, for example, the horizontal direction. In the third direction, two sides of the housing 20 are located opposite to each other. As described above, in the case where the air current does not uniformly flows into the housing 20, the inclination of the main surface 81b is changed depending on the flow direction of the air current, that is, depending on the position of the opening portion 25. As a result, the air current easily flows along the rectifying surface 81 of the rectifying member 80, and the flow of the air current into the inner circumferential region 65 of the fan 60 is facilitated.

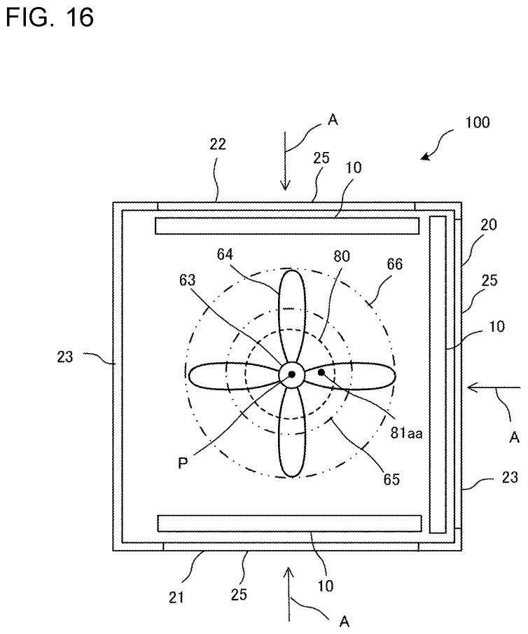

FIG. 16 is a plan view illustrating a configuration of an air-conditioning apparatus 100 of a modification of Embodiment 4. Referring to FIG. 16, three heat exchangers 10 are provided for the front side 21, the back side 22, and one of the lateral sides 23 of the housing 20. Therefore, the air current flows into the housing 20 from the front side 21, the back side 22, and one of the lateral sides 23 of the housing 20, but does not flow into the housing 20 from the other lateral side 23. In this case, the apex 81aa of the upstream-side distal end surface 81a is located at a position shifted from the central axis P toward the opening portion 25 on the lateral side 23 where one of the heat exchangers 10 is provided, as in Embodiment 4. However, in the case illustrated in FIG. 16, since the three heat exchangers 10 are provided, the apex 81aa may be shifted toward any of the three heat exchangers 10, but it should be noted that in the plane of the drawing of FIG. 16, the three heat exchangers 10 are provided such that no heat exchanger 10 is located on the left side and one of the three heat exchangers 10 is located on the right side. Therefore, in the case of FIG. 16, it is preferable that the apex 81aa be located at a position shifted from the central axis P in the direction away from the other lateral side 23 where no heat exchanger 10 is provided. Therefore, in the case of FIG. 16, as indicated by a black dot, the apex 81aa is located at a position shifted from the central axis P toward the opening portion 25 on the lateral side 23 where one of the heat exchangers 10 is provided. By virtue of this configuration, it is possible to obtain the same advantages as in Embodiment 4.

As illustrated in FIG. 14, the compressor 2, the four-way valve 7, the expansion device 5, a control box 8, an accumulator 9, and other components are provided in the housing 20. It is thus conceivable that these internal components can each be an obstacle to the flow of the air current. However, even in this case, it is possible to cause the air current to smoothly flow, by locating the apex 81aa of the upstream-side distal end surface 81a at a position shifted from the central axis P depending on the flow direction of the air current as illustrated in FIG. 14, in such a manner as to prevent the air current from striking against the above internal components. As a result, the fan efficiency of the fan 60 can be improved. Therefore, for example, as illustrated in FIG. 5 relating to Embodiment 1, even in the case where the four heat exchangers 10 are provided, Embodiment 4 is still effective, provided that the apex 81aa is shifted in consideration of the locations of the internal components.

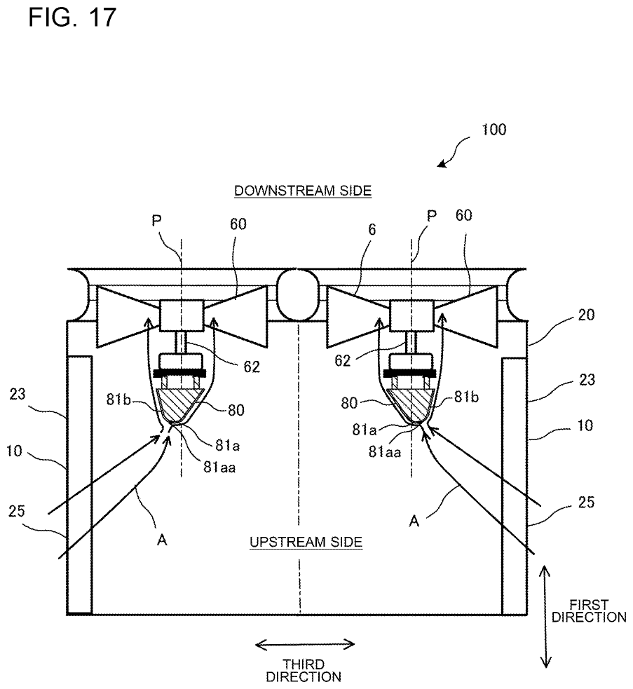

FIG. 17 is a front view illustrating a configuration of an air-conditioning apparatus 100 of another modification of Embodiment 4. FIG. 17 illustrates the case where two fans 60 are provided in the housing 20. It should be noted that the heat exchangers 10 are located to face respective two lateral sides 23. The rectifying members 80 are each provided for an associated one of the fans 60. In this case also, as in Embodiment 4, the apex 81aa of the upstream-side distal end surface 81a of each of the rectifying members 80 is located at a position shifted from the central axis P toward the opening portion 25 on the lateral side 23 where the associated heat exchanger 10 is provided. Thus, it is possible to obtain the same advantages as in Embodiment 4.

As described above, in Embodiment 4, the rectifying member 80 is provided as in Embodiments 1 and 2, to thereby facilitate the flow of the air current that flows into the inner circumferential region 65 of the fan 60 and improve the fan efficiency.

In Embodiment 4, as in Embodiment 2, the gap 70 is provided between the upstream-side end portion 90a of the motor support base 90 and the downstream-side end portion 82 of the rectifying member 80. It is therefore possible to reduce the growth of the boundary layer 50, and reduce the probability that a turbulent air current will flow into the inner circumferential region 65 of the fan 60.

Furthermore, in Embodiment 4, the flow rate of the air current in a circumferential direction of the fan 60 varies depending on the location of the heat exchanger 10 which is located close to an air inlet of the housing 20, or depending on the locations of internal components such as the compressor 2 in the housing 20. Therefore, in the vicinity of the rectifying member 80, the flow of the air current is inclined relative to the central axis P of the fan 60. Thus, the apex 81aa of the upstream-side distal end surface 81a of the rectifying member 80 is displaced from the central axis P of the fan 60, whereby the inclination of the main surface 81b can be changed depending on the flow direction of the air current. Accordingly, it is possible to facilitate the flow of the air current into the inner circumferential region 65 of the fan 60, and improve the fan efficiency.

### Embodiment 5

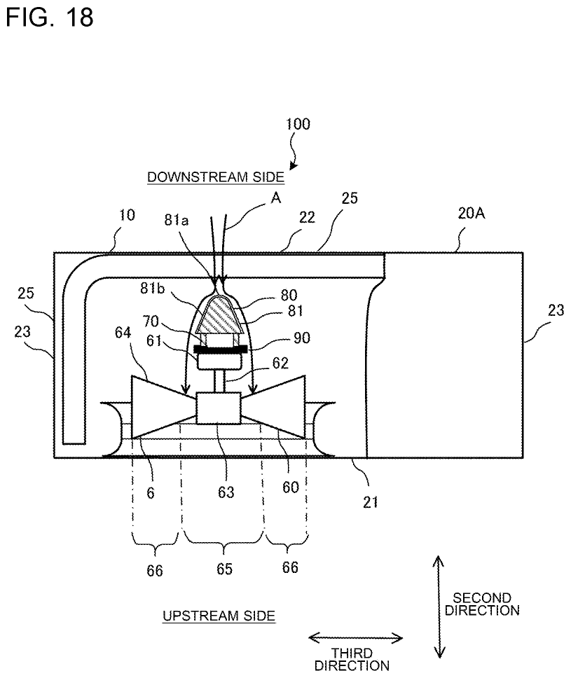

FIG. 18 is a plan view illustrating a configuration of the air-conditioning apparatus 100 according to Embodiment 5. FIG. 18 illustrates the air-conditioning apparatus 100 according to Embodiment 5 as viewed from above. Regarding Embodiments 1 to 4, the fan 60 is described above with respect to the case where the fan 60 is provided in the upper portion of the housing 20. In contrast, in Embodiment 5, as illustrated in FIG. 18, the fan 60 is provided to face the front side 21 of a housing 20A. The heat exchanger 10 is L-shaped and is located to face the back side 22 and one of the lateral sides 23 of the housing 20A. In Embodiment 5, the air conditioning apparatus 100 is such a side-blow type air-conditioning apparatus 100 as to have the above shape and will be described below.

In Embodiment 5, as illustrated by arrows A, the air current is sucked into the housing 20A from the back side 22 of the housing 20A by driving of the fan 60. The sucked air current passes through the heat exchanger 10, flows through the air sending device 6, and is blown out of the housing 20A from the front side 21 of the housing 20A. Therefore, the back side 22 is an upstream side, and the front side 21 is a downstream side.

In Embodiment 5, the rectifying member 80 is provided upstream of the motor support base 90 in the flow direction of the air current as in Embodiments 1 to 4. The rectifying member 80 has the same configuration as the rectifying member 80 described regarding Embodiments 1 to 4. The rectifying member 80 has the rectifying surface 81 configured to change the flow direction of the air current in such a manner as to cause the air current to flow toward the inner circumferential region 65 of the fan 60. The rectifying surface 81 includes the main surface 81b that is tapered toward the upstream side in the flow direction of the air current. The rectifying member 80 includes the upstream-side distal end surface 81a having a spherical shape. The rectifying member 80 protrudes in the second direction which intersects the third direction. The downstream-side end portion 82 of the rectifying member 80 is fixed to the motor support base 90. The upstream-side distal end surface 81a of the rectifying member 80 is located to face the back side 22 of the housing 20A. The downstream-side end portion 82 of the rectifying member 80 is located to face the front side 21 of the housing 20A.

Since the other structural elements are the same as those in Embodiments 1 to 4, they will be denoted by the same reference sings as in Embodiments 1 to 4, and their descriptions will thus be omitted.

As described above, also, the side-blow type air-conditioning apparatus 100 can obtain the same advantages as in Embodiments 1 to 4.

It should be noted that in Embodiments 1 to 5, in the case where the heat exchanger 10 is provided for two adjacent sides of the housing 20 or 20A, the heat exchanger 10 which is L-shaped as illustrated in FIG. 18 may be used. Likewise, in the case where the heat exchanger 10 is provided for three sides of the housing 20 or 20A, the heat exchanger 10 which is U-shaped may be used.

Furthermore, the configurations of the air sending device 6 and the air-conditioning apparatus 100 which are described above regarding Embodiments 1 to 5 can be applied to the indoor air sending device 4 and the second air-conditioning apparatus 101 which are provided as illustrated in FIG. 1. Also, in this case, it is possible to obtain the same advantages as in Embodiments 1 to 5.

1. An air sending device comprising:
a housing;
a fan motor provided in the housing and having a rotation shaft;
a fan attached to the rotation shaft and configured to be driven and rotated by the fan motor to generate an air current;
a motor support base attached to the housing, provided upstream of the fan and the fan motor in a flow direction of the air current, and supporting the fan motor; and
a rectifying member provided on an upstream side that is located upstream of the motor support base in the flow direction of the air current, protruding in a direction from the motor support base toward the upstream side, and having a rectifying surface configured to change the flow direction of the air current in such a manner as to cause the air current to flow toward an inner circumferential region of the fan,
wherein the rectifying surface of the rectifying member includes
an upstream-side distal end surface formed spherically, and
a main surface that is located between the upstream-side distal end surface and the motor support base, forms an outer peripheral surface of the rectifying member, and is tapered in a direction away from the motor support base.

2. The air sending device of claim 1, wherein the rectifying member has a downstream-side end portion located adjacent to the motor support base in the flow direction of the air current.

3. The air sending device of claim 1, wherein
the rectifying member has a downstream-side end portion located to face the motor support base in the flow direction of the air current, and
a gap is provided between the downstream-side end portion of the rectifying member and the motor support base.

4. The air sending device of claim 2, wherein
a longitudinal direction of the motor support base is the same direction as a second direction intersecting a first direction that is an axial direction of the rotation shaft,
a short-side direction of the motor support base is the same direction as a third direction intersecting the first direction and the second direction,
both end portions of the motor support base in the longitudinal direction are attached to the housing,
the downstream-side end portion of the rectifying member has an outside diameter that is smaller than or equal to a length of the motor support base in the short-side direction, and
a virtual surface located to extend from the main surface of the rectifying surface toward a downstream side in the flow direction of the air current is located outward of the both end portions of the motor support base in the short-side direction.

5. The air sending device of claim 1, wherein an apex of the upstream-side distal end surface formed spherically is located on a central axis of the rotation shaft of the fan motor, the rotation shaft extending in the first direction.

6. The air sending device of claim 1, wherein
the housing has an opening portion through which air of the air current is sucked from the outside of the housing, and
the apex of the upstream-side distal end surface formed spherically is located at a position that is shifted from the central axis of the rotation shaft of the fan motor toward the opening portion and according to the flow direction of the air current, the rotation shaft extending in the first direction.

7. An air-conditioning apparatus comprising:
the air sending device of claim 1; and
a heat exchanger provided in the housing,
wherein the heat exchanger is provided upstream of the air sending device in the flow direction of the air current.
